(19) United States
(12) Patent Application Publication
(10) Pub. No.: US 2025/0353359 A1
(43) Pub. Date: Nov. 20, 2025

(54) INFINITELY ADJUSTABLE FLIP-UP WINDSHIELD

(71) Applicant: Super ATV, LLC, Madison, IN (US)

(72) Inventors: Patrick Draper, Delaware, OH (US); Colton Pifer, North Vernon, IN (US)

(73) Assignee: Super ATV, LLC, Madison, IN (US)

(21) Appl. No.: 18/665,971

(22) Filed: May 16, 2024

(51) Int. Cl. B60J 1/04

(52) U.S. Cl. CPC B60J 1/04

(57) ABSTRACT

An adjustable windshield for a vehicle. The windshield is rotatably attached to the vehicle and is positionable at any angle relative to the vehicle including and between a fully closed position and a fully open position. A locking strut is connected between the windshield and the vehicle. The locking strut has a barrel portion, an arm portion, and an actuator. The actuator defines a first position and a second position. In the first position, the arm portion of the strut is fixed relative to the barrel portion; in the second position, the arm portion of the strut is movable relative to the barrel portion. Movement of the arm portion relative to the barrel portion adjusts the angle of the windshield relative to the vehicle. The windshield includes a controller operatively connected to the actuator of the strut where the controller is spaced apart from the strut.

### FIELD

This disclosure generally relates to motor vehicles and, more particularly, pertains to adjustable windshields for off-road motor vehicles.

### BACKGROUND

The present disclosure relates to adjustable windshields for off-road motor vehicles such as all-terrain vehicles (“ATVs”) and utility-terrain vehicles (“UTVs”). Many OEM off-road vehicles do no come equipped with a front windshield. Similar to standard commercial vehicles, outfitting an off-road vehicle provides protection from the elements, including raid, wind, or snow, while also providing safety from foreign objects, which is particularly helpful in rough-terrain situations that ATVs or UTVs are used in.

Many after-market solution provide static windshields that cover part or all of the front of the vehicle. Still other solutions include electric windshield that will open or close automatically. However, the electric options on the market require invasive installation to connect the windshield to the battery of the vehicle and to install an electrical switch to open or close the windshield.

Lastly, some use-conditions for such vehicles may require the windshield to be adjusted to a position between fully opened and fully closed. For example, an operator using a UTV for hunting may desire to have a partially opened front windshield for hunting purposes. Others may desire a partially or fully open windshield configuration for air flow while parked or to feel the breeze while driving.

### SUMMARY

The present disclosure includes certain embodiments for an adjustable windshield for off-road vehicles and methods of using such adjustable windshields. In certain embodiments of the present invention, an adjustable windshield assembly includes a windshield rotatably attached to an off-road vehicle via one or more struts. The struts comprise a barrel portion, an arm portion that is selectively movable relative to the barrel portion, and an actuator to place the strut in a first, movable position or a second, fixed position. In certain embodiments, the struts comprise gas-filled struts. In other embodiments, the struts comprise liquid-filled struts.

The adjustable windshield assembly includes a controller that is operatively connected to the strut(s). In certain embodiments, the controller is connected to the actuator(s) of the strut(s) by a cable, such as a Bowden cable. In other embodiments, the controller is electrically connected to the actuator(s) of the strut(s) by electric cabling and the actuator(s) comprise electric solenoids. The controller actuates the actuator(s) to place said actuators in the first, movable position, which allows the windshield to rotate relative to the vehicle. The controller is also configured to actuate the actuator(s) to the second, fixed position. This allows the windshield to be locked at a discrete, particular angle relative to the vehicle. Embodiments of the present disclosure allow the windshield to be placed at or between a fully closed position and a fully open position.

In certain embodiments, the controller comprises a lever. The lever may be centrally located or otherwise located apart from the strut(s). Rotation of the lever in the first direction places the actuator(s) in the first position by placing tension on the cables, which allows the windshield to rotate relative to the vehicle. Rotation of the lever in the second direction, opposite the first direction, places the actuator(s) back in the second position.

In certain embodiments, the adjustable windshield assembly includes a locking mechanism for securing the windshield in the fully closed position. In one embodiment, the controller comprises a lever that includes a locking extension. The locking extension acts as a tab that is engageable with a locking receptacle attached to the vehicle. Engagement of the locking extension with the locking mechanism locks the rotational movement of the windshield. Rotation of the lever-type controller simultaneously rotates the locking extension to disengage the locking extension from the locking receptacle and allowing rotational movement of the windshield relative to the vehicle.

### BRIEF DESCRIPTION OF THE DRAWINGS

FIG. 1 is a front perspective view of a vehicle outfitted with an embodiment of an adjustable windshield in a fully closed position according to the present disclosure.

FIG. 2 is a front perspective view of the adjustable windshield of FIG. 1 in a partially open configuration.

FIG. 3 is a zoomed in, rear view of an embodiment of an adjustable windshield.

FIG. 4 is a side view of an embodiment of an adjustable windshield in a closed position.

FIG. 5 is a side view of an adjustable windshield locked in a partially open position.

FIG. 6 is a zoomed in view of an actuator attached to a locking strut.

FIG. 7 is a zoomed in view of a lever-type controller of an embodiment of an adjustable windshield.

FIG. 8 is a side cross-sectional view of the lever-type controller of FIG. 7.

FIG. 9 is a bottom cross-sectional view of the lever-type controller.

FIG. 10 is a front cross-sectional view of a lever-type controller in a second position.

FIG. 11 is a cross-sectional view of a lever-type controller in a first position.

FIG. 12 is a flow chart of an embodiment of a method of adjusting a windshield to an open position according to the present disclosure.

FIG. 13 is a flow chart of an embodiment of a method of adjusting a windshield to a fully closed position according to the present disclosure.

### DETAILED DESCRIPTION

For the purposes of promoting an understanding of the principles of the disclosure, reference will now be made to certain embodiments and specific language will be used to describe the same. It will nevertheless be understood that no limitation of the scope of the disclosure is thereby intended, such alterations and further modifications, and such further applications of the principles of the disclosure as described herein being contemplated as would normally occur to one skilled in the art to which the disclosure relates. Additionally, in the detailed description below, numerous alternatives are given for various features. It will be understood that each such disclosed alternative, or combinations of such alternatives, can be combined with the more generalized features discussed in the Summary above, or set forth in the embodiments described below to provide additional disclosed embodiments herein.

The uses of the terms “a” and “an” and “the” and similar references in the context of the disclosure (especially in the context of the following claims) are to be construed to cover both the singular and the plural unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element.

The present disclosure includes certain embodiments for an adjustable windshield for off-road vehicles and methods of using such adjustable windshields. In certain embodiments of the present disclosure, an adjustable windshield assembly includes a windshield rotatably attached to an off-road vehicle via one or more struts. The struts comprise a barrel portion, an arm portion that is selectively movable relative to the barrel portion, and an actuator to place the strut in a first, movable position or a second, fixed position. In certain embodiments, the struts comprise gas-filled struts. In other embodiments, the struts comprise liquid-filled struts.

The adjustable windshield assembly includes a controller that is operatively connected to the strut(s). In certain embodiments, the controller is connected to the actuator(s) of the strut(s) by a cable, such as a Bowden cable. In other embodiments, the controller is electrically connected to the actuator(s) of the strut(s) by electric cabling and the actuator(s) comprise electric solenoids. The controller actuates the actuator(s) to place said actuators in the first, movable position, which allows the windshield to rotate relative to the vehicle. The controller is also configured to actuate the actuator(s) to the second, fixed position. This allows the windshield to be locked at a discrete, particular angle relative to the vehicle. Embodiments of the present disclosure allow the windshield to be placed at or between a fully closed position and a fully open position.

In certain embodiments, the controller comprises a lever. The lever may be centrally located or otherwise located apart from the strut(s). Rotation of the lever in the first direction places the actuator(s) in the first position by placing tension on the cables, which allows the windshield to rotate relative to the vehicle. Rotation of the lever in the second direction, opposite the first direction, places the actuator(s) back in the second position.

In certain embodiments, the adjustable windshield assembly includes a locking mechanism for securing the windshield in the fully closed position. In one embodiment, the controller comprises a lever that includes a locking extension. The locking extension acts as a tab that is engageable with a locking receptacle attached to the vehicle. Engagement of the locking extension with the locking mechanism locks the rotational movement of the windshield. Rotation of the lever-type controller simultaneously rotates the locking extension to disengage the locking extension from the locking receptacle and allowing rotational movement of the windshield relative to the vehicle.

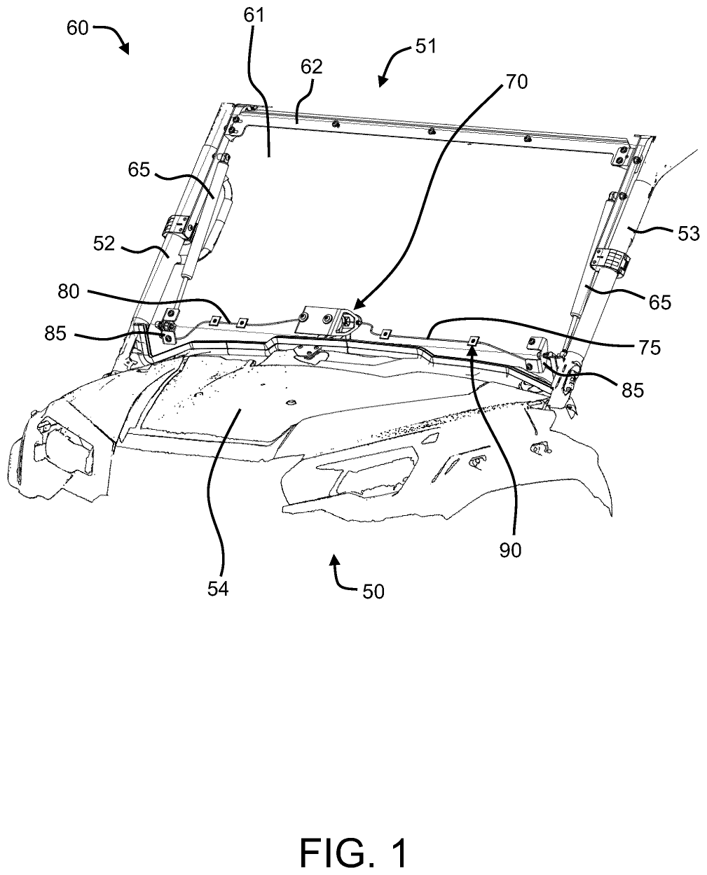

FIG. 1 illustrates a front perspective view of an embodiment of an adjustable windshield assembly 60 attached to a vehicle 50 in a fully closed position. The vehicle 50 generally includes a roof 51 supported by vertical posts 52, 53, and a hood 54. As shown, the assembly 60 includes a windshield 61. The windshield 61 includes a frame 62 that is secured to the vehicle 50. Specifically, the windshield 61 is rotatably attached to frame 62. In this embodiment, the frame 61 is attached to vertical posts 52, 53 of vehicle 50. Attachment of frame 62 to the vehicle 50 positions windshield 61 such that the windshield 61 is rotatable relative to vehicle 50 and vertical posts 52, 53.

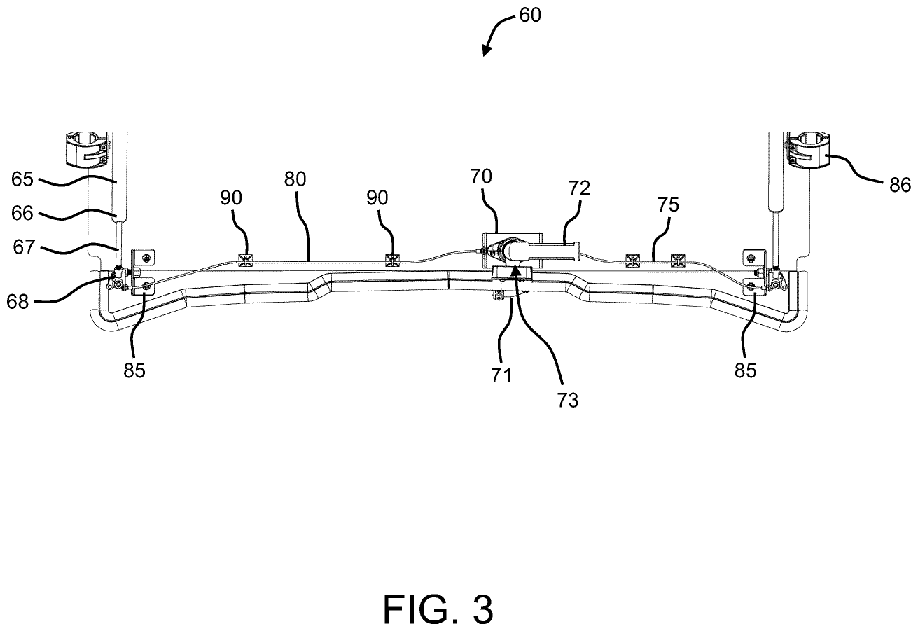

The assembly 60 further includes locking struts 65 connected to the frame 62 and the windshield 61 via brackets 85. The struts include actuators 68 that open or close the struts by allowing movement of an arm portion of the strut relative to the barrel portion (see FIG. 3). Movement of the strut(s) 65 adjusts the relative angle of the windshield 61 relative to vehicle 50. In this embodiment, two locking struts 65 are used to support the position of the windshield 61 when not in a closed position/configuration. In other embodiments, one or more than two struts 65 may be used to adjust the angle of windshield 61.

Assembly 60 further includes a controller 70. The controller 70 actuates the actuators 68 to open and/or close the windshield 61. In this embodiment, controller 70 is centrally located and spaced apart from both locking struts 65. The controller is operatively connected to the actuators 68 of struts 65. In this embodiment, cables 75, 80 connect controller 70 to the struts 65. The cables 75, 80 comprise a Bowden cable or tension cable. In some embodiments, some or all of the cable 75, 80 is wrapped in a sheath of protective material. In yet further embodiments, the cables comprise an electric cable and the actuator 68 comprises an electric solenoid.

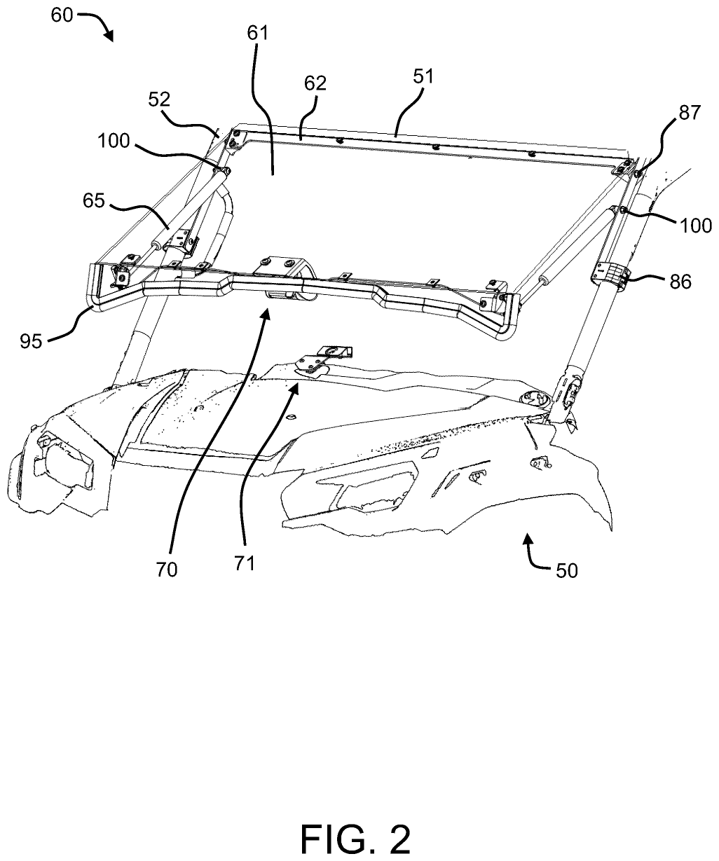

FIG. 2 illustrates the windshield assembly 60 of FIG. 1 in a partially opened position. Actuating the actuators 68 via the controller 70 allows the arm portion of the struts 65 to move relative to the barrel portion which permits adjusting the angle of the windshield 61 relative to vehicle 50 via rotation at hinge point 100. This will be discussed in more detail, below.

In this embodiment, frame 62 of assembly 60 includes clamps 86 and fasteners 87 to secure the frame 62 to the vertical posts 52, 53 and roof 51, respectively. Other attachment mechanisms are also envisioned within the spirit of the present disclosure. In some embodiments, windshield 61 is rotatable relative to fasteners 87, in addition to hinge point 100, as will be appreciated by those of skill in the art.

At illustrated, the windshield 61 may have a non-planar shape. Said differently, the windshield 61 may be any shape suitable to secure to an OEM off-road vehicle. Optionally, one or more edges of the windshield 61 are outfitted with a seal 95 to provide a fluid-tight engagement between windshield 61 and vehicle 50 when windshield 61 is in a closed position/configuration.

FIG. 3 is a rear view of the bottom portion of the windshield assembly 60. As shown, the struts 65 include a barrel portion 66, an arm portion 67, and an actuator 68. The actuator is positionable in a first position and a second position. Specifically, the arm portion 67 is movable relative to the barrel portion 66 when the actuator 68 is in the first position and the arm portion 67 is fixed relative to the barrel portion 66 when the actuator 68 is in the second position. Movement of the arm portion 67 relative to the barrel portion 66 allows adjusting the angle of the windshield 61 relative to the vehicle 50. By selectively actuating the actuator 68 between the first and second positions, an operator of vehicle 50 can manually place the windshield 61 at any angle between and including the fully closed position and the fully open position.

In this embodiment, the controller 70 includes a lever 72 and a locking extension 73. Additionally, the vehicle 50 includes a locking receptacle 71 attached to the hood 54. In this embodiment, rotation of lever 72 actuates the actuator 68. Specifically, the lever 72 is operatively connected to actuator 68 via cable 80. Rotation of the lever 72 about its central axis in a first direction places tension on cable 80 which opens actuator 68 allowing movement between arm portion 67 and barrel portion 66 of strut 65. Said differently, rotation of lever 72 causes the actuator 68 to go from its second position to its first position, thus allowing the angle between the windshield 61 and vehicle 50 to be moved. Rotating the lever 72 in a second direction about its central axis, said second direction being opposite the first direction, places the actuator 68 back in its second, locked position. In this embodiment, lever 72 rotates ˜ninety degrees) (90°) about its central axis to place the actuator 68 in the first position, and vice versa. In other embodiments, the lever 72 may be rotated between sixty degrees (60°) and one-hundred and twenty degrees (120°) to actuate actuator 68.

The controller 70 also includes a locking extension 73 and a locking receptacle 71 coupled to vehicle 50. The locking extension 73 engages the locking receptacle 71 to secure the windshield 61 in the fully closed position. When the lever 72 is rotated to open windshield 61, the locking extension 73 attached to lever 72 is also rotated thereby disengaging locking extension 73 from locking receptacle 71. In other embodiments, a different locking mechanism may be used to secure the windshield 61 in the fully closed position.

As illustrated, the cable(s) 75, 80 may be secured to the interior-facing surface of windshield 61 via one or more anchors 90.

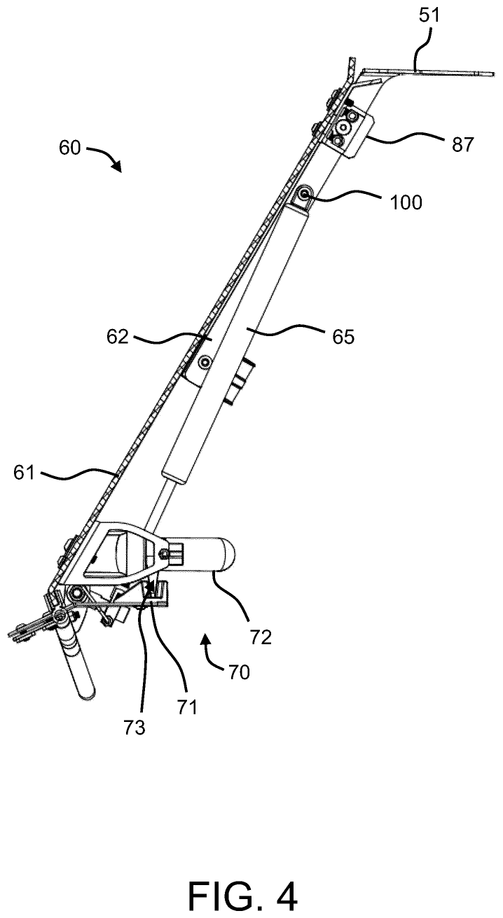

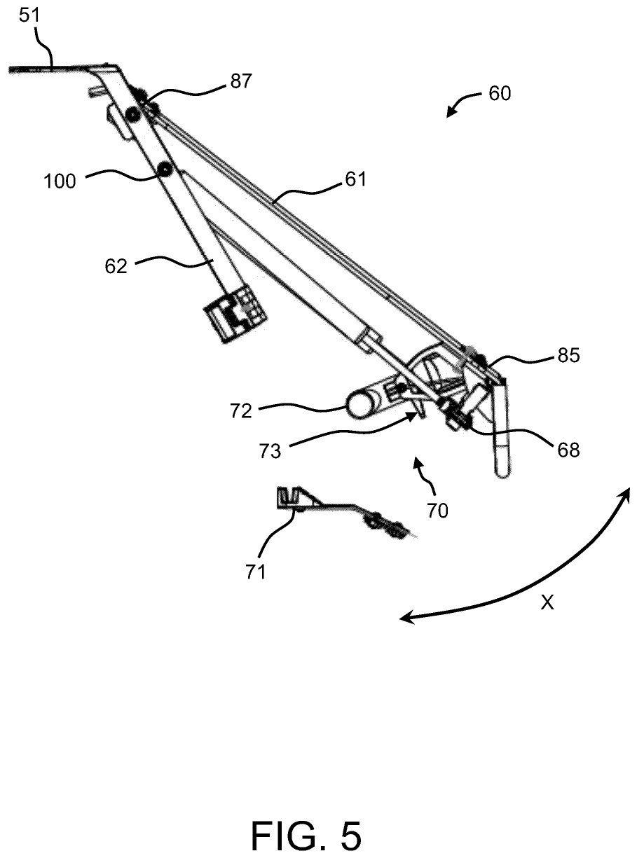

At FIGS. 4 and 5, two positions of a windshield 61 are disclosed. FIG. 4 illustrates a side view of the windshield 61 in a fully closed position. FIG. 5 is a side view of the oppose side of windshield 61 showing the windshield 61 in a partially open configuration. At FIG. 4, the locking extension 73 of lever 72 is engaged with locking receptacle 71, securing the windshield in the closed position. The actuator 68 is in the second position and the struts are fixed at the closed angle.

At FIG. 5, the lever 72 has been rotated in a first direction, causing the actuator to be placed in the first, movable position, said movement allowing the windshield 61 to rotate relative to vehicle 50, as denoted by arrows X. Simultaneously, rotation of lever 72 disengaged locking extension 73 from the locking receptacle 71. The lever 72 was then rotated in a second direction about its central axis, opposite the first direction (the position illustrated in FIG. 5). Rotating lever 72 in the second direction causes the actuator 68 to be placed back in the second position, thereby locking strut 65 and securing the windshield 61 at a discrete angle relative to the vehicle 50.

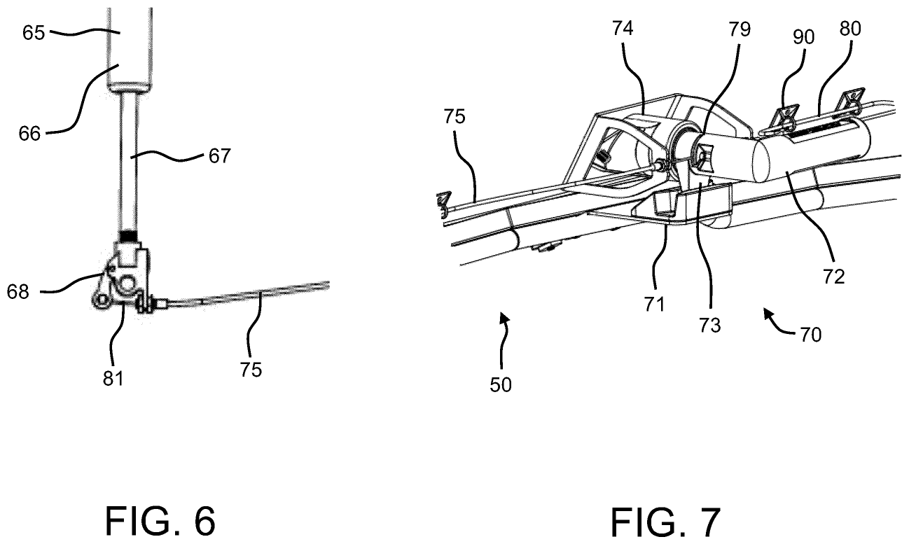

FIG. 6 is a zoomed in view of a strut 65 including the barrel portion 66, the arm portion 67, and the actuator 68. In this embodiment, the strut 65 is a liquid-filled strut. In other embodiments, the strut 65 is a gas-filled strut (e.g., LPG/Lipinge part number 10/22-603-200-135N; Bansbach/Easylift part number KOA3KX-2-255-878/265N). In yet further embodiments where more than one strut 65 is used, a combination of struts may be employed. Regardless of the embodiment, the actuator(s) 68 of the strut(s) 65 are biased towards the second position. Said differently, the actuator(s) 68 are biased to keep the strut(s) 65 in a locked/fixed configuration. Optionally, however, a spring 81 may be used to further bias the actuator(s) 68 in the second position. Although shown near the actuator 68, a spring may additionally or alternatively be placed near the controller 70 to perform a similar function.

In operation of select embodiments utilizing one or more fluid-filled strut(s) 65, actuator 68 opens or closes a valve within the strut 65 allowing movement of fluid within the barrel portion 66. Movement of the fluid while the valve is open (i.e., when actuator 68 is actuated) allows extension of the arm portion 67 relative to barrel portion 66, thereby allowing rotation of windshield 61 relative to frame 62 and vehicle 50. When actuation of actuator 68 ceases, the valve closes, preventing movement of the fluid between components of the strut 65, thereby blocking further movement of the arm portion 67 relative to the barrel portion 66 and ceasing movement of windshield 61. Manually pulling windshield 61 from an open configuration towards the closed configuration with the valve open forces the fluid to move in the opposite direction, allowing retraction of arm portion 67 relative to barrel portion 66.

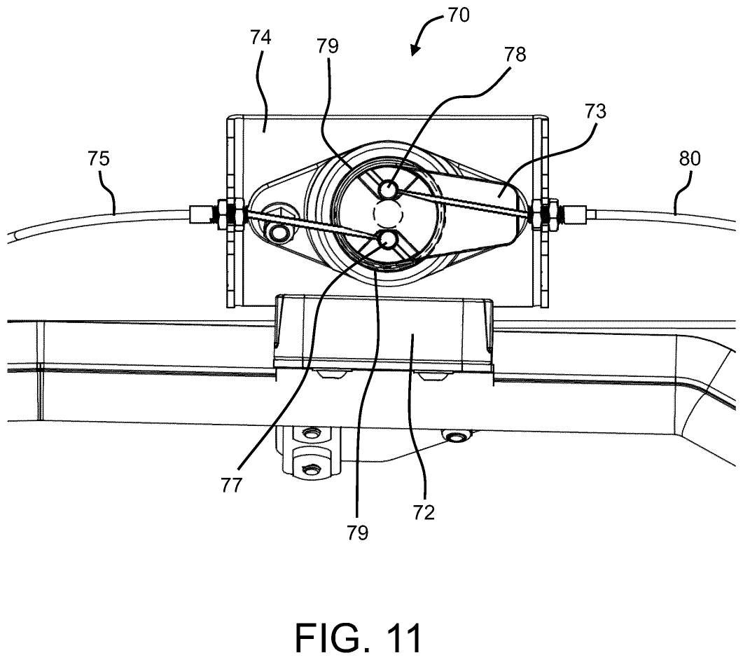

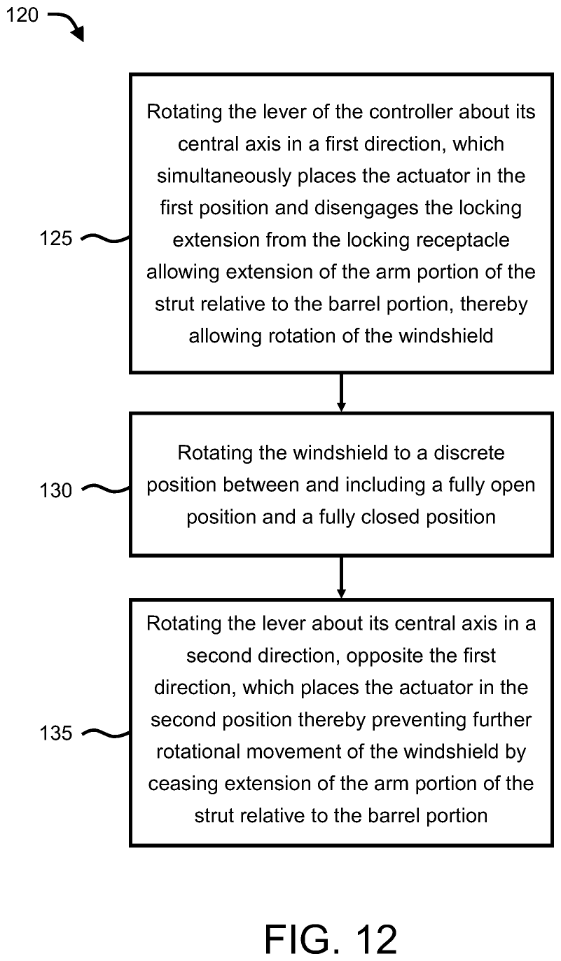

FIG. 7 is a zoomed in view of an embodiment of a controller 70. In this embodiment, the controller 70 is operatively coupled to the actuators 68 via tension cables 75, 80. The controller comprises a lever 72 secured to the windshield 61 by base 74. Additionally, the locking extension 73 extends from lever 72 and engages locking receptacle 71 to secure the windshield 61 in the fully closed position. The lever 72 further defines a cavity 79 which forms a connection point for cables 75, 80, respectively. Connection of cables 75, 80 in this manner allows for rotation of lever 72 to place tension on said cables 75, 80 to actuate actuators 68 to adjust the angle of windshield 61. This will be discussed with more detail with reference to FIGS. 11 and 12.

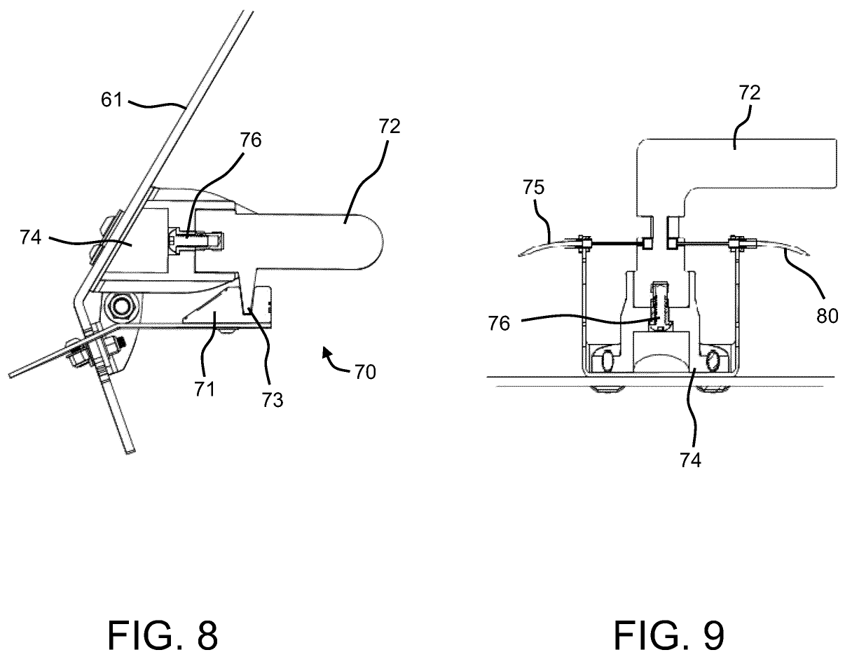

FIG. 8 is a side, cross-sectional view of the controller 70 illustrated in FIG. 7. As shown, the base 74 is securely fastened to the windshield 61. Lever 72, which includes the locking extension 73, is rotatably secured to the base 74, and this windshield 61, via fastener 76. As shown, the locking receptacle 71 attached to vehicle 50 proves a recess that receives the locking extension 73 of controller 70. The locking receptacle 71 is configured to prevent movement of windshield 61 in the direction of rotation of the windshield 61 (see arrows X in FIG. 5). In this embodiment, the locking receptacle 71 is not configured to prevent rotational movement of lever 72. In other embodiments, a secondary lock may be used to prevent rotational movement of lever 72. For example, a lever could prevent rotation movement of lever 72. In other embodiments, the receptacle 71 defines a friction lock with lock extension 73 thereby resisting rotational movement of lever 72. For example, the receptacle 71 and lock extension may each be made of rubber or other similar materials that have a high frictional coefficient sufficient to resist rotational movement of lever 72 when lock extension 73 is engaged with receptacle 71. Other locking mechanisms will be appreciated by those of skill in the art. FIG. 9 is a bottom, cross-sectional schematic view of the controller 70 illustrated in FIG. 8.

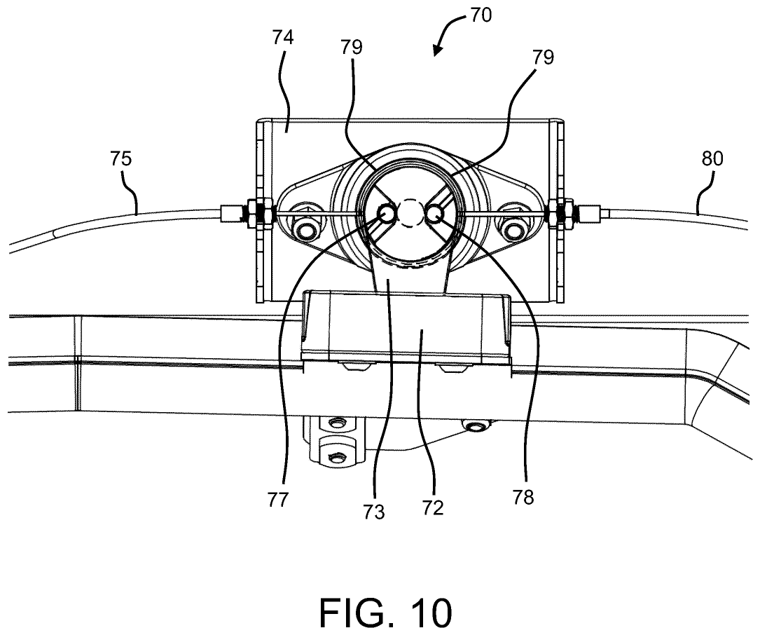

FIGS. 10 and 11 illustrate how rotation of lever 72 actuates the actuators 68 via cables 75, 80. FIG. 10 is a cross-sectional view of the controller 70 of FIG. 8 when actuators 68 are in the second position (i.e., fixed/locked position). FIG. 11 is a cross-sectional view of the controller 70 when actuators 68 are in the first position (i.e., movable position). The cables 75, 80 are attached to anchor points 77, 78, respectively, within cavity 79. As the lever 72 rotates (from FIG. 10 to FIG. 11), the anchor points 77, 78 of controller 70 are also rotate, which causes the cables 75, 80 to be partially taken up/wrapped around a portion of cavity 79. Said differently, in FIG. 10 the cables are parallel to a transverse axis of the lever 72. As the lever 72 is rotated, the cables 75, 80 are pulled and tightened such that they are no longer parallel with the transverse axis of lever 72. The pulling/tension placed on the cables causes actuation of actuators 68 and forces them into the first position (movable position).

FIG. 12 is a method 120 of adjusting a windshield 61 to an open position. At 125, the lever 72 of the controller 70 is rotated about its central axis in a first direction placing the actuator 68 in the first position and releasing the locking extension 73 from the locking receptacle 71, simultaneously. At 130, the windshield 61 is rotated to a discrete position. At 135, the lever 72 is rotated about its central axis in a second direction, said second direction opposite the first direction, placing the actuator 68 in the second position.

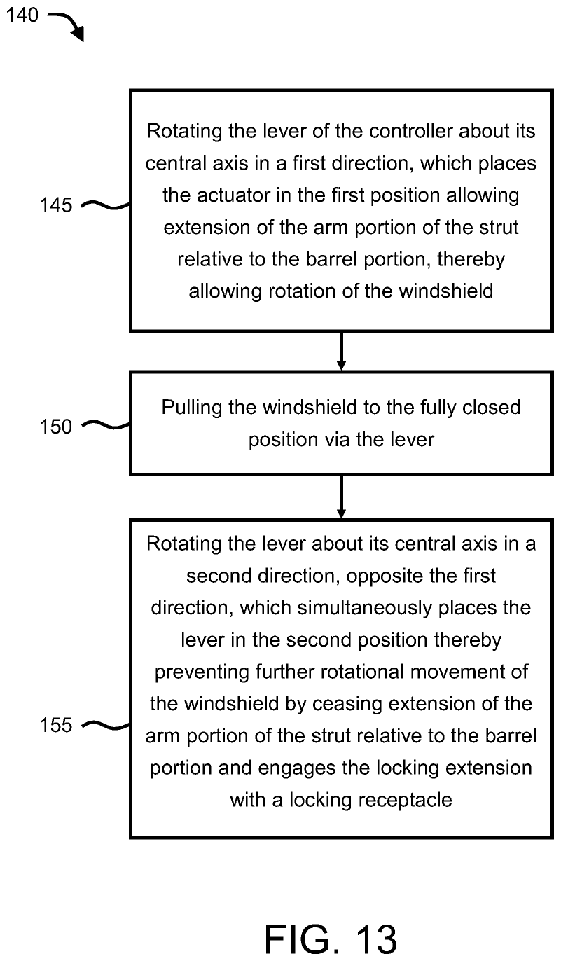

FIG. 13 is a method 140 of adjusting a windshield 61 to a fully closed position. At 145, the lever 72 is rotated in the first direction placing the actuator 68 in the first position. At 150, the windshield 61 is pulled to the closed position via the lever. At 155, the lever is rotated in the second direction placing the actuator 68 in the second position and engaging the locking extension 73 with the locking receptacle 71, simultaneously.

While the invention has been described in detail in the foregoing description, the same is to be considered as illustrative and not restrictive in character, it being understood that all changes and modifications that come within the spirit of the invention are desired to be protected. In addition, all references cited herein are indicative of the level of skill in the art and are hereby incorporated by reference in their entirety.

What is claimed:

1. An adjustable windshield for a vehicle, the apparatus comprising:
a windshield rotatably attached to the vehicle wherein said windshield is positionable at any angle relative to the vehicle including and between a fully closed position and a fully open position;
a locking strut connected between said windshield and the vehicle, wherein the strut comprises a barrel portion, an arm portion and an actuator defining a first position and a second position, wherein the arm portion is movable relative to the barrel portion when the actuator is in the first position and wherein the arm portion is fixed relative to the barrel portion when the actuator is in the second position, wherein movement of the arm portion relative to the barrel portion adjusts the angle of the windshield relative to the vehicle; and
a controller operatively connected to the actuator, wherein the controller is spaced apart from said locking strut.

2. The apparatus of claim 1, wherein the controller is operatively connected to the actuator via a cable.

3. The apparatus of claim 2, wherein the controller comprises a lever configured to rotate about a central axis, wherein rotation of said lever moves said actuator between the first position and the second position.

4. The apparatus of claim 3, wherein the lever further comprises a locking extension and a locking receptacle configured to be secured to the vehicle and to receive the locking extension when the windshield is in the fully closed position.

5. The apparatus of claim 4, wherein a secondary lock releasably locks the lever relative to the locking receptacle.

6. The apparatus of claim 2, wherein the adjustable windshield comprises a second locking strut, including a second actuator operatively coupled to the controller via a second cable, wherein the controller is also spaced apart from said second locking strut, and wherein the second locking strut is spaced apart form the first locking strut.

7. The apparatus of claim 2, wherein the cable comprises a Bowden cable.

8. The apparatus of claim 1, wherein the actuator is biased toward the second position.

9. The apparatus of claim 1, further comprising a spring that biases the actuator toward the second position.

10. The apparatus of claim 3, wherein said lever is coupled to said windshield.

11. The apparatus of claim 2, wherein the cable connecting the controller to the strut comprises an electric cable that operates the actuator.

12. The apparatus of claim 1, wherein said locking strut is filled with a fluid and includes a valve, wherein actuation of the actuator opens or closes the valve allowing or preventing movement of fluid within the strut.

13. A method of utilizing the apparatus of claim 3, comprising:
rotating the lever of the controller about its central axis in a first direction placing the actuator in the first position;
rotating the windshield to a discrete position; and
rotating the lever about its central axis in a second direction, said second direction opposite the first direction placing the actuator in the second position.

14. The method of claim 13, wherein during the step of rotating the lever of the controller about its central axis in a first direction simultaneously releases a locking extension of the lever from a locking receptacle secured to the vehicle.

15. The method of claim 14, further comprising:
rotating the lever in the first direction placing the actuator in the first position;
moving the windshield to the closed position; and
rotating the lever in the second direction placing the actuator in the second position and engaging the locking extension with the locking receptacle, simultaneously.

16. A kit comprising components of the apparatus of claim 2, including:
the windshield;
the strut;
the controller;
the actuator; and
the cable
wherein the components are preassembled into an adjustable windshield.

17. The kit of claim 16, wherein the controller comprises a lever configured to rotate about a central axis, wherein rotation of said lever moves said actuator between the first position and the second position.

18. The kit of claim 17, wherein the kit includes additional components including an additional strut, an additional cable, and/or an additional actuator.

19. The kit of claim 17, wherein the lever further comprises a locking extension and a locking receptacle configured to be secured to the vehicle and to receive the locking extension when the windshield is in the fully closed position.

20. The kit of claim 17, wherein the controller comprises a button, the cable comprises an electric cable, the strut comprises a fluid-filled strut, and the actuator comprises an electric solenoid.
